(19) United States
(12) Patent Application Publication
(10) Pub. No.: US 2008/0283199 A1
(43) Pub. Date: Nov. 20, 2008

(54) Techniques used with solutions of solids in a liquid for separating the liquid from a solid

(76) Inventor: William F. Hartman, Albuquerque, NM (US)

Correspondence Address: GORDON E NELSON;PATENT ATTORNEY, PC, 57 CENTRAL ST, PO BOX 782, ROWLEY, MA, 01969, US

(21) Appl. No.: 12/120,996

(22) Filed: May 15, 2008

Related U.S. Application Data
(60) Provisional application No. 60/938,047, filed on May 15, 2007.

(51) Int. Cl. B01D 1/16

(52) U.S. Cl. 159/4.01; 159/48.1

(57) ABSTRACT

Techniques used with a solution in which a solid is dissolved in a liquid. In one technique, drops of the solution are sprayed into a stream of gas. The drops are sized to fall through and out of the stream of gas before they are completely evaporated. The partial evaporation leaves the solid entrapped in the drops and the evaporated vapor in the stream of gas. In another technique, the drops are carried by the stream of gas. As the drops are carried, most of the drops are completely evaporated, producing vapor and particles of the solid. A filter filters out the particles. Some of the drops are not completely evaporated when they reach the filter and solution from these drops continuously rinses the filter. Large drops of the rinsing solution fall from the filter, through the stream of gas, and out of the stream of gas.

### CROSS-REFERENCE TO RELATED APPLICATIONS

This application claims priority from U.S. provisional patent application No. 60/938,047, William F. Hartman, Gravity enhanced separation of sohite from evaporating liquids, filed May 15, 2007. This application further incorporates U.S. Pat. No. 6,699,369, William Francis Hartman, et al., Apparatus and method for thermal desalination based on pressurized formation and evaporation of droplets, issued Mar. 2, 2004, into the present patent application by reference for all purposes.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

1. Field of the Invention

The invention relates generally to techniques employed with solutions that consist of solids dissolved in a liquid to separate the liquid from the solids and more specifically to thermal desalination

2. Description of Related Art

The techniques disclosed herein may be practiced in a class of thermal desalinators in which a saline solution is sprayed into a continuous flow of hot air. The drops of the spray are carried by the flow of hot air and the hot air evaporates the water in the drops. One example of the class is the desalinator described in U.S. Pat. No. 6,699,369, cited above (henceforth “the '369 patent”). As described in the '369 patent and shown in FIG. 1 of that patent, the flow of hot air is produced by blower 26 and heat provided by heat exchanger 20. Nozzle 16 sprays drops of salt water into chamber 18 through which the flow of hot air is moving. In chamber 18, the flow of hot air evaporates the water contained in the drops of salt water. As a consequence, the flow of hot air now carries water vapor from the water in the drops and salt particles. The flow of hot air passes through filter 22, which filters out the salt particles and then through a condenser 12 which condenses the water vapor. A requirement of the desalinator of the '369 patent is that the salt particles that accumulate in the filter be removed. The technique for so doing that is suggested in the '369 patent is periodically rinsing the filter. One way of rinsing the filter is to install and regulate an additional nozzle or nozzles.

Desalinators of the class disclosed in the '369 patent and other desalinators need techniques that either provide for cleaning the filter during normal operation of the desalinator without additional nozzles or render the filter unnecessary. It is an object of the present patent application to provide such techniques.

### BRIEF SUMMARY OF THE INVENTION

The foregoing object is attained by a method which may be employed with any solution in which a solid is dissolved in a liquid to separate the liquid from the solid. In the method, an evaporation process is employed to partially evaporate drops of the solution. The solid remains entrapped in the partially evaporated drops, the partially evaporated drops are removed from the evaporation process, and the liquid is obtained from the vapor that results from the partial evaporation.

Other aspects of the method include the following: an evaporation process which exposes the drops to a gas that is at a temperature which causes evaporation; spraying the drops into the gas in the evaporation process; having the drops fall through the gas in the evaporation process; removing the partially evaporated drops by having the drops fall out of the gas, and having the partially evaporated drops that fall out of the gas fall into a receptacle.

Still other aspects include the following: the drops include first drops which evaporate completely in the gas and second drops which do not evaporate completely and the method includes the steps of using a filter to remove the solid from the evaporated first drops from the gas and removing the second drops from the evaporation process by employing the solution in the second drops to rinse the filter. The method may further include the step of forming third drops from the solution used to rinse the filter. The third drops are heavy enough to fall through the gas and to not evaporate completely prior to removal from the gas. The third drops may be removed from the gas by falling out of the gas, and may fall out of the gas by falling into a receptacle.

Further aspects include apparatus which operates in the manner just described to separate a solid from the liquid in which the solid is dissolved, a desalinator which includes a filter that filters out salt particles and employs the techniques just described for rinsing the filter, and a desalinator which employs the techniques just described to eliminate the need for a filter.

Other objects and advantages will be apparent to those skilled in the arts to which the invention pertains upon perusal of the following Detailed Description and drawing, wherein:

### BRIEF DESCRIPTION OF THE SEVERAL VIEWS OF THE DRAWINGS

FIG. 1 illustrates a desalinator of the class described above in which the filter is continuously cleaned during normal operation of the desalinator.

FIG. 2 illustrates such a desalinator in which no filter is required.

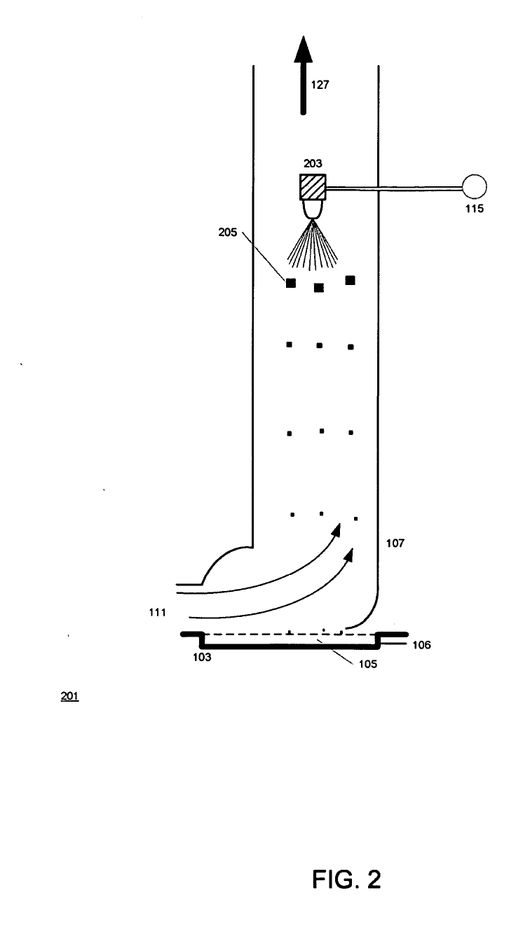

Reference numbers in the drawing have three or more digits: the two right-hand digits are reference numbers in the drawing indicated by the remaining digits. Thus, an item with the reference number 203 first appears as item 203 in FIG. 2.

### DETAILED DESCRIPTION OF THE INVENTION

In the following, embodiments of the foregoing techniques are shown in which the techniques are used to desalinate salt water. In one of the embodiments, partially-evaporated drops of salt water are used to rinse a filter which removes salt particles from a stream of air; in another, the use of partially-evaporated drops to entrap the salt eliminates the need for the filter. In both embodiments, the stream of air is vertical and partially-evaporated drops fall through the vertical flow of air.

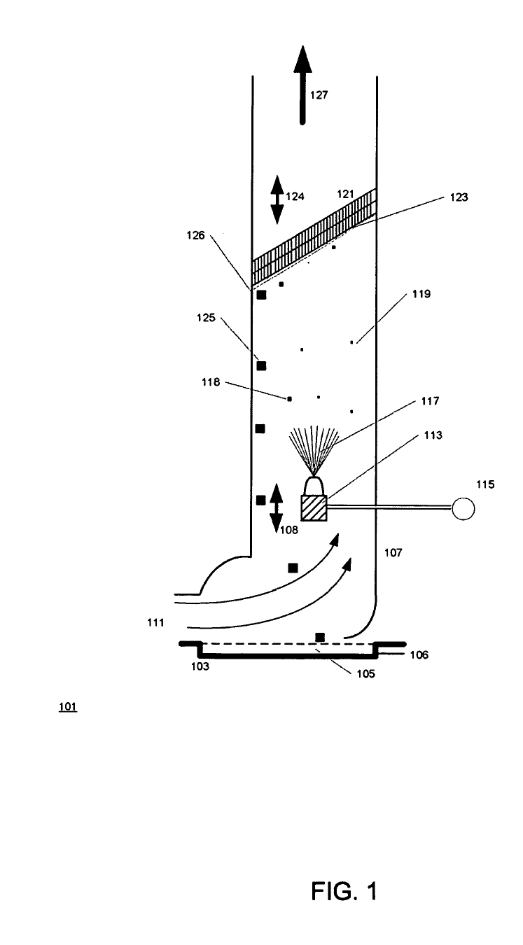

A Desalinator with a Self-Cleaning Filter: FIG. 1

FIG. 1 shows a technique 101 for making the filter in a desalinator like the one described in the '369 patent self cleaning. In the technique, the salt water is sprayed vertically upwards into a vertical chamber 107 through which a stream of hot air 111 is flowing. The stream of hot air 111 carries the drops of the spray upward and the drops evaporate as they are carried upward. However, a small percentage of the droplets reach inclined filter 121 without evaporating completely and provide a rinsing action that employs gravity. Specifically, the process is:

A stream of hot air enters as shown at 111 and is channeled past the nozzle(s) 113, which sprays droplets 117 having a broad size distribution (118, 119) By adjusting the distance between nozzle 113 and inclined filter 121 (both nozzle and filter are movable, as shown at 124 and 108), the spacing may be fixed so that a small amount of droplets reach the filter before evaporating completely. The droplets combine and dissolve the salt particles on the filter to form a concentrated brine 123. The concentrated brine 123 flows down the inclined filter to point 126. There, large heavy brine drops 125 are formed. The brine drops are so large and heavy that they fall through stream of hot air 111 instead of being carried upward and evaporating and also are not completely evaporated as they fall. A brine pool 103 is located at the bottom of vertical chamber 117. The brine drops 125 fall into pool 103. The brine 105 in pool 103 exits at waste out 106. The filter is self cleaned due to this action and the hot air 111 containing the water vapor moves freely through filter 123 and on to the condenser, as shown by arrow 127. Brine 105 may be treated as waste or added to the salt water which is input to the desalinator.

A Desalinator which does not Require a Filter: FIG. 2

FIG. 2 shows a technique 201 for eliminating the filter. Nozzle 203 sprays droplets 205 vertically downwards into stream of hot air 111. The size of the droplets is chosen such that substantially all of the droplets fall down through stream of hot air 111 and such that substantially none of the droplets fully evaporates during the fall. Consequently, substantially all of the salt is entrapped in concentrated form in the partially evaporated drops, which fall into pool 103. Above nozzle 203, stream of hot air 111 contains substantially no salt particles, but only water vapor. Consequently, no filter is required. Specifically, the process is:

Hot air enters at 111 and is channeled past the nozzle(s) 203, which sprays droplets 205 having a narrow size distribution. By adjusting the distance between the nozzle and the brine pool 103, the spacing may be fixed so that all droplets reach brine pool 103 before evaporating completely. The water in droplets 205 evaporates as the droplets fall through hot air 111, and consequently, the droplets 205 are much larger upon leaving nozzle 203 than they are when they reach pool 103. Because the dissolved salts remain in a droplet 205 as the droplet's water is evaporated, all salts are collected in pool 103 and the concentrated brine may be output at 106. The concentrated brine that is output at 106 may be dealt with as described above.

It should be pointed out here that the above process is a specific example of a general technique in which an evaporation process is used to partially evaporate drops of a solution which has a liquid and a solid component, the partially-evaporated drops are removed from the evaporation process, and the liquid component is obtained from the vapor resulting from the partial evaporation.

Conclusion

The foregoing Detailed Description has disclosed to those skilled in the relevant arts techniques that may be used with solutions of solids in a liquid to separate the liquid from the solids. The techniques may be used to construct evaporative desalinators which have self-cleaning salt filters or no salt filters at all. The Detailed Description has further disclosed the best mode known to the inventor for constructing evaporative desalinators which incorporate the principles of the techniques disclosed herein.

It will be immediately apparent to those skilled in the relevant technologies that the techniques disclosed herein may be employed with any solution of solids in a liquid and that there are many possible methods of partially evaporating the drops of solution, of removing the partially-evaporated drops from the solution, and of obtaining the liquid from the vapor resulting from the partial evaporation. There are further many ways of implementing the embodiment of FIG. 1 such that enough droplets reach the filter to rinse it and of implementing the embodiment of FIG. 2 so that no droplets evaporate before reaching the bottom of the chamber. Specific implementations will depend on variables such as the kind of solution from which the liquid is being separated, the temperature of the gas, and the sizes and range of sizes of the droplets produced by the nozzles.

For all of the foregoing reasons, the Detailed Description is to be regarded as being in all respects exemplary and not restrictive, and the breadth of the invention disclosed herein is to be determined not from the Detailed Description, but rather from the claims as interpreted with the full breadth permitted by the patent laws.

1. A method employed with a solution in which a solid is dissolved in a liquid of separating the liquid in the solution from the solid therein comprising:
employing an evaporation process to partially evaporate drops of the solution;
removing the partially evaporated drops from the evaporation process; and
obtaining the liquid from a vapor that results from the partial evaporation, whereby the solid remains entrapped in the removed drops.

2. The method set forth in claim 1 wherein:
the evaporation process is exposing the drops to a gas that is at a temperature which causes evaporation of the liquid.

3. The method set forth in claim 2 wherein:
the drops are exposed to the gas by spraying the drops into the gas.

4. The method set forth in claim 2 wherein:
the drops fall through the gas.

5. The method set forth in claim 4 wherein:
in the step of removing, the drops fall out of the gas.

6. The method set forth in claim 5 wherein:
the drops fall out of the gas into a receptacle.

7. The method set forth in claim 2 wherein
the drops include first drops which evaporate completely in the gas and second drops which do not evaporate completely therein and the method further comprises the steps of:
using a filter to remove the solid from the evaporated first drops from the gas; and
removing the second drops from the evaporation process by employing the solution in the second drops to rinse the filter.

8. The method set forth in claim 7 wherein the step of removing the second drops by employing the solution in the second drops to rinse the filter comprises the step of:
forming third drops from the solution used to rinse the filter, the third drops being heavy enough to fall through the gas and to not evaporate completely prior to removal from the gas.

9. The method set forth in claim 8 wherein:
the third drops are removed from the gas by falling out of the gas.

10. The method set forth in claim 9 wherein:
the third drops fall out of the gas into a receptacle.

11. Apparatus employed with a solution in which a solid a solid is dissolved in a liquid for separating the liquid in the solution from the solid therein, the apparatus comprising:
an evaporator in which drops of the solution are partially evaporated;
a drop remover that removes partially evaporated drops from the evaporator; and
a condenser that condenses a vapor resulting from the partial evaporation of the drops.

12. The apparatus set forth in claim 11 wherein:
the evaporator exposes the drops to a gas which is at a temperature that causes evaporation of the liquid.

13. The apparatus set forth in claim 12 wherein
the evaporator comprises:
a sprayer that sprays the drops into the gas.

14. The apparatus set forth in claim 12 wherein:
in the evaporator, the drops fall through the gas.

15. The apparatus set forth in claim 14 wherein:
the drop remover enables the drops to fall out of the gas.

16. The apparatus set forth in claim 15 wherein the drop remover comprises:
a receptacle into which the drops fall.

17. The apparatus set forth in claim 12 wherein
the drops include first drops which evaporate completely in the gas and second drops which do not evaporate completely therein and the apparatus further comprises:
a filter that removes the solid from the evaporated first drops from the gas and further functions as the drop remover for the second drops, the second drops rinsing the solid from the filter.

18. The apparatus set forth in claim 17 wherein:
the second drops form third drops in the filter that are heavy enough to fall through the gas and to not evaporate completely prior to being removed from the gas by the drop remover.

19. The apparatus set forth in claim 18 wherein:
the remover enables the drops to fall out of the gas.

20. The apparatus set forth in claim 19 wherein the remover comprises:
a receptacle into which the drops fall.

21. A desalinator of the class wherein a nozzle sprays drops of a salt solution into a stream of air that evaporates the drops to produce water vapor and salt particles in the stream of air and includes a filter to filter the salt particles out of the stream of air, the desalinator having the improvement comprising:
a substantially vertical stream of air;
an arrangement of the filter and the nozzle such that
the filter is inclined from the horizontal;
the nozzle is at a distance from the filter such that some of the drops have not completely evaporated when the drops reach the filter;
the drops that reach the filter coalesce and the coalesced drops and the filter's inclination produce a flow of the rinsing liquid across the filter, the rinsing liquid dissolving salt particles in the filter; and
drops of the rinsing liquid that drain from the filter have a size such that the drops of rinsing liquid fall through the stream of air without being completely evaporated, whereby the salt dissolved in the drops of rinsing liquid is removed from the filter.

22. A desalinator of the class wherein a nozzle sprays drops of a salt solution into a stream of air that evaporates the drops to produce water vapor in the stream of air, the desalinator having the improvement comprising:
a substantially vertical stream of air; and
a nozzle that produces drops having a size such that substantially all of the produced drops fall through the stream of air and out of the stream of air before the produced drops are completely evaporated,
whereby the salt remains in the incompletely evaporated drops, the stream of air remains free of salt particles and no filter is required to remove the salt particles from the stream of air.
